(19) United States
(12) Patent Application Publication
(10) Pub. No.: US 2011/0031840 A1
(43) Pub. Date: Feb. 10, 2011

(54) Electrical Drive Machine

(75) Inventors: Gerhard Huth, Hohenroth-Leutershausen (DE); Markus Reinhard, Nürnberg (DE)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT, MUNICH (DE)

(21) Appl. No.: 12/736,545

(22) PCT Filed: Mar. 26, 2009
(86) PCT No.: PCT/EP2009/053602

§ 371 Date: Oct. 18, 2010

(30) Foreign Application Priority Data
Apr. 18, 2008 (DE) 10 2008 019 644.4

(51) Int. Cl. H02K 3/00

(52) U.S. Cl. 310/195; 310/40 R

(57) ABSTRACT

In a drive system, including a stator and a rotor associated with an energy transmission system supplying energy to a load on the rotor, the drive function and the energy transmission function are largely independent of each other. A subharmonic air gap field portion is used for transmitting electric energy to a rotor winding.

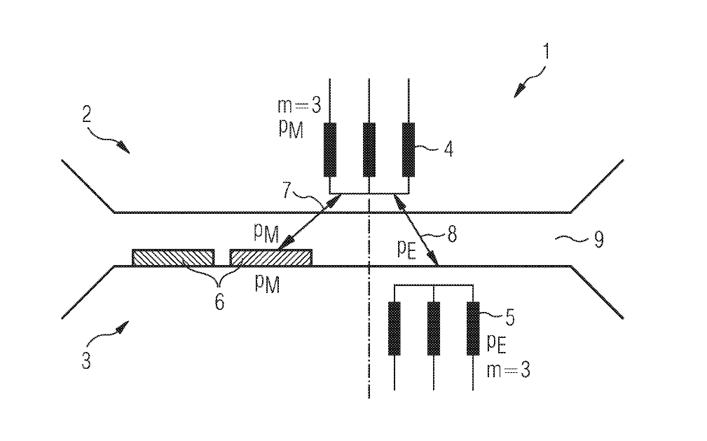

### CROSS REFERENCE TO RELATED APPLICATIONS

This application is the U.S. national stage of International Application No. PCT/EP2009/053602, filed Mar. 26, 2009 and claims the benefit thereof. The International Application claims the benefits of German Application No. 10 2008 019 644.4 filed on Apr. 18, 2008, both applications are incorporated by reference herein in their entirety.

### BACKGROUND

Described below is an electrical drive machine having a stator and a rotor, which form a drive system, with which a power transmission system for supplying electrical power to a load on the moving part is associated, wherein the drive function and the power transmission function are largely independent of one another.

By way of example, a drive machine such as this is designed on the principle of a synchronous machine or an asynchronous machine and may be used as linear drive or rotary drive. The electrical drive machine includes a stator and a moving rotor. For some applications, for example in the case of machine tools and production machines, it is necessary to transmit electrical power to the rotor, for example in the form of a shaft or a spindle. The electrical power can be used, inter alia, for supplying safety devices, sensors, data transmission systems or actuators (for example for tool clamping).

A suitable power transmission system is required to transmit power for drive machines. A power transmission system such as this must be integrated in the drive machine, or must be fitted separately.

By way of example, electrical power can be transmitted to the rotor by conductive coupling. By way of example, sliprings can be used in this case, which are simple and reliable, but which require considerable maintenance effort. Furthermore physical space is required for the slipring apparatus. An alternative option for conductive coupling is to use trailing cables. The problem in this case is a restrictive maximum possible rotation angle and the risk of cable fracture as a result of a continuous bending load on the cable.

Alternatively, electrical power can be transmitted to the rotor by inductive coupling. The described problems relating to conductive coupling can be overcome by inductive coupling. In this case, a primary polyphase winding (primary winding) is located on the stator of the drive machine, and a second winding (secondary winding) is located on the rotor of the drive machine. A feed device, for example a frequency converter, feeds a three-phase voltage system into the primary winding. In order to improve the efficiency, the windings are inserted into a ferromagnetic active part, or are wound around a ferrite core.

If, in addition to the transmission of electrical power to the rotor, a drive is required, the inductive transmitter described above is, for example, flange-connected to an electric motor. This consumes additional physical space. Furthermore, the two active parts for the electric motor and the transmitter undesirably result in high costs.

In order to avoid this DE 10 2005 024 203 A1 discloses an electrical drive machine of this generic type, in which the electrical windings of the drive system and of the power transmission system are introduced into a common active part, wherein, however, the drive function and the power transmission function are independent of one another. In this case, the power is transmitted to the rotor inductively, thus allowing decoupled operation of the power transmission and motor operation. Two inverters are provided and are fed from a common voltage intermediate circuit or from separate voltage intermediate circuits, depending on the requirement. One of the inverters is responsible for the motor, and the other inverter is responsible for the power transmission.

### SUMMARY

An aspect is an electrical drive machine which advantageously develops the drive machine known from the related art and allows inductive power transmission to a rotor in a manner involving a simpler design.

The electrical drive machine includes a stator and a rotor, which form a drive system, in which there is an associated power transmission system for supplying electrical power to a load on the rotor, wherein the drive function and the power transmission function are largely independent of one another. In this case, subharmonic air-gap field components (so-called subharmonics) in the air-gap field are used to transmit electrical power to a rotor winding.

The power transmission may be integrated in the active part of a motor, thus making it possible to manufacture this motor physically more easily. No additional physical space is therefore required for the transmitter for the electrical power to the rotor. This also ensures that the drive function and the power transmission function are very largely decoupled from one another. Inductive power transmission ensures low costs and little maintenance effort, in comparison to a solution based on sliprings. Furthermore, inductive power transmission does not involve any brush wear, thus likewise reducing the maintenance effort and ensuring a high hygiene standard. There are no shutdown costs resulting from brush changing or replacement of trailing cables. The disadvantage of the restricted rotation angle when using trailing cables is likewise eliminated. The electrical drive machine allows any desired rotation angles. Furthermore, inductive power transmission allows use in explosion-hazardous areas.

In one expedient refinement, the stator has a common active part which includes a (common) stator winding for the drive function and the power transmission function, in which a motor current system and a power current system, which is superimposed on the motor current system and differs from it, can be fed in or are fed in. In comparison to the electrical drive machine described in DE 10 2005 024 203 A1, only a single winding need be provided on the stator, and is used for both the drive function and the power transmission function. This allows the electrical drive machine to be made more compact and more physically simple than the related art.

According to one further refinement, the stator winding is a toothed-coil winding. Toothed-coil windings are always fractional-slot windings. The number of slots in the stator winding is therefore formed by a fractional number. Fractional-slot windings have the characteristic of also producing subharmonics in the air-gap field. A subharmonic air-gap field component such as this is used to transmit the electrical power to the rotor winding.

In particular, the rotor has permanent magnets for the drive function and the rotor winding for the power transmission function. According to this refinement, the electrical drive system can be based on a synchronous machine with permanent-magnet excitation in which, as explained, only a single active part, for example laminated core, is required for the stator winding, in order to provide both the drive function and the power transmission function.

According to a further refinement, the number of pole pairs in the rotor winding corresponds to a number of pole pairs of a subharmonic in the air-gap field. The number of pole pairs of the permanent magnets is in contrast chosen such that this corresponds to a number of pole pairs developed from the stator winding, ideally for the maximum possible winding factor. This allows an efficient drive to be produced.

The permanent magnets can optionally be arranged in the air gap of the drive machine or buried in the rotor.

In order to produce the motor current system and the power transmission system, a converter, for example a frequency converter, is coupled to the stator winding. In contrast to electrical drive machines from the related art, a single converter is in this case sufficient to provide the motor current system and the power current system, thus allowing the electrical drive machine according to the invention to be produced more cost-effectively. Expediently, the power current system is at a higher frequency than the motor current system. The high-frequency power current system admittedly causes oscillating torques. However, these are damped by the inertia of the motor. In this case, the frequency of, e.g., the low-frequency motor current system, is chosen such that no undesirable effect can be expected from the motor current in the rotor-side “power winding” (rotor winding). This is the case when the motor current does not transmit any power, and the power current does not produce any torque.

### BRIEF DESCRIPTION OF THE DRAWINGS

These and other aspects and advantages will be explained in more detail in the following text with reference to one exemplary embodiment in the drawing.

The single FIGURE shows a schematic electrical drive machine in which a subharmonic air-gap field is used to transmit electrical power to a rotor of the drive machine.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

The drive machine 1 includes a stator 2 and a rotor 3. It may be used as a linear drive or as a rotary drive. The power transmission system is formed by a stator winding 4 in the stator 2, and by a rotor winding 5 in the rotor 3. The drive system is formed by the stator winding 4 and permanent magnets 6 in or on the rotor 3. The stator 2 and the rotor 3 are isolated from one another in a known manner by an air gap 9. The stator winding is connected to a single-phase or three-phase electrical power supply system via a converter, which is not illustrated in the FIGURE. An electrical load, which is likewise not illustrated, is connected to the rotor winding 5. By way of example, the load may be a safety device, a sensor system or an actuator system. A voltage intermediate circuit can optionally be provided between the rotor winding 5 and the electrical load, and is fed from a rectifier. A step-up converter, a step-down converter or an inverter can be connected downstream from this. The voltage intermediate circuit itself is supplied with the power transmitted at the terminals of the rotor winding 5.

As is immediately evident, the electrical drive system is based on the principle of a synchronous machine with permanent-magnet excitation, in which electrical power is transmitted inductively to the rotor 3. In this case, the drive machine 1 has the characteristic that only a single active part is required for the stator winding 4. By way of example, the active part may be formed by a laminated core. This is fitted with the stator winding 3, which has three winding sections in the exemplary embodiment and uses toothed-coil technology. The number of slots q in the rotating-field winding on the stator side is calculated as follows:

$$q = \frac{N}{2 \cdot m \cdot p} = \frac{z}{n} . \qquad ( 1 )$$

Where N is the number of stator slots, m is the number of winding sections and p is the number of pole pairs, z is the numerator for the number of slots, and n is the denominator for the number of slots. m is normally 3. Since toothed-coil windings are always fractional-slot windings, the number of slots q represents a fractional number. The typical characteristic of fractional-slot windings, of also being able to produce subharmonic components in the air-gap field, is made use of by the drive system since a subharmonic air-gap field component, also referred to as subharmonics, is used to transmit electrical power to the rotor system.

In order to produce the drive for the electrical drive machine 1, the rotor 3 is fitted with the permanent magnets 6 with the number of pole pairs p_{M}, corresponding to the or a developed number of pole pairs p_{M} of the stator winding 4. In this case, it is worthwhile using that number of pole pairs p_{M} whose winding factor is as high as possible, in order to achieve an efficient drive. The number of pole pairs p_{E} in the rotor winding 5 corresponds to the number of pole pairs p_{E} of the selected subharmonics. The indices “M” and “E” respectively denote the motor function and the power function of the electrical drive machine 1.

In general, the number of pole pairs ν produced by a polyphase fractional-slot winding is calculated as follows:

$$v = p + 2 \cdot m \cdot \frac{p}{n} g , g = 0 , \pm 1 , \pm 2 , \pm 3 , … , \qquad ( 2 )$$

where

v harmonic numbers of pole pairs that occur,

p number of pole pairs,

m number of winding sections,

n denominator of the number of slots q from equation (1),

g sequential parameter for harmonics.

The number of pole pairs p_{M} developed from the stator winding 4 is defined as the basic field number of pole pairs (cf. also reference sign 7). As explained, this should have as high a winding factor as possible for an efficient drive. The magnets 6, which can be buried or arranged in the air gap 9 in the drive machine 1, are designed corresponding to this number of pole pairs p_{M}. The rotor winding 5 must couple with one subharmonic of the stator winding 4. The number of pole pairs p_{E} in the rotor winding 5 is chosen in a corresponding manner. The stator winding is fed with a motor current system by the converter mentioned initially. In addition, this converter feeds in a higher-frequency power current system, which is superimposed on the motor current system. The oscillating torque caused by the higher-frequency power current system is damped by the inertia of the rotor of the electric motor.

An example of a drive machine could be designed as follows:

Number of stator slots: N=24,

Number of pole pairs for the motor function: p_{M}=10,

Number of winding sections: m=3

The number of slots in the stator winding is given, on the basis of equation (1), by:

$${q}_{i} = \frac{N}{2 \cdot m \cdot p} = \frac{24}{2 \cdot 3 \cdot 10} = \frac{2}{5} . \qquad ( 3 )$$

According to equation (2), the following numbers of pole pairs can occur:

$$v = p + 2 \cdot m \cdot \frac{p}{n} g = 10 + \frac{6 \cdot 10}{5} g . \qquad ( 4 )$$

This results, for the numbers of pole pairs which occur, in:

ν=10+12g= . . . , −14,−2,10,22, . . . (for g=0,±1,±2, . . . ).

The winding factor for the number of pole pairs 10 (g=0, that is to say there is a fundamental which is injected directly into the permanent magnets 6 of the drive machine) turns out to be 0.933. The winding factor for the number of pole pairs 2 turns out to be 0.067. If this subharmonic is used, then the rotor winding 5 can be designed with four poles, that is to say p_{E}=2. If, in contrast, an integer-slot winding is chosen for the rotor winding 5, then the number of rotor slots is given by:

N₂=2·m·p_{E}·q₂=2·3·2·q₂=12·q₂ q₂=1,2,3, . . . (5).

The electrical drive machine has the advantage that the power transmission can be integrated in the active part of a motor, and no physical space is therefore required for the power transmitter to the rotor. This allows the motor function and the power transmission function to be very largely decoupled from one another. The relative movement between the rotor and the stator may be rotary. However, the relative movement may also be linear. The permanent magnets may be formed on the air gap or buried in the rotor. Air-gap magnets may in this case be secured by a binding. The drive machine may be designed as an internal rotor or external rotor machine.

The stator winding may be in the form of a toothed-coil winding, thus allowing the drive machine to be manufactured easily. In addition to a single stator winding, only a single converter is likewise required. The rotor winding can feed a load directly or by intermediate power electronics.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-10. (canceled)

11. An electrical drive machine associated with a power transmission system, comprising:
a drive system, including a stator and a rotor having a rotor winding, associated with the power transmission system that supplies electrical power to a load on the rotor, where a drive function and a power transmission function are largely independent of one another and a subharmonic air-gap field component is used to transmit the electrical power to the rotor winding.

12. The drive machine as claimed in claim 11, wherein the stator has a common active part, comprising a stator winding for the drive function and the power transmission function, into which is fed a motor current system and a power current system superimposed on the motor current system and differing therefrom.

13. The drive machine as claimed in claim 12, wherein the stator winding is a toothed-coil winding.

14. The drive machine as claimed in claim 13,
wherein the rotor winding provides the power transmission function, and
wherein the rotor comprises permanent magnets for the drive function.

15. The drive machine as claimed in claim 14, wherein the rotor winding has a number of pole pairs corresponding to a number of pole pairs of a subharmonic of the air-gap field.

16. The drive machine as claimed in claim 14, wherein a number of pole pairs of the permanent magnets corresponds to a number of pole pairs, developed from the stator winding, for a maximum possible winding factor.

17. The drive machine as claimed in claim 16, wherein the electrical drive machine has an air gap in which the permanent magnets are arranged.

18. The drive machine as claimed in claim 17, wherein the permanent magnets are buried in the rotor.

19. The drive machine as claimed in claim 18, further comprising a converter, coupled to the stator winding, producing the motor current system and the power current system.

20. The drive machine as claimed in claim 19, wherein the power current system is at a higher frequency than the motor current system.
